(19) United States
(12) Patent Application Publication
(10) Pub. No.: US 2008/0083576 A1
(43) Pub. Date: Apr. 10, 2008

(54) Regenerative energy storage system for hybrid locomotive

(76) Inventor: David H. Read, Dexter, MI (US)

Correspondence Address: David H. Read;US EPA/NVFEL, 2565 Plymouth Rd., Ann Arbor, MI, 48105, US

(21) Appl. No.: 11/807,405

(22) Filed: May 29, 2007

Related U.S. Application Data
(60) Provisional application No. 60/849,286, filed on Oct. 4, 2006.

(51) Int. Cl. B60K 6/20; B60T 13/00

(52) U.S. Cl. 180/165; 303/3; 903/907; 903/947

(57) ABSTRACT

An energy storage car for a locomotive includes a hydraulic energy storage system designed to capture and reuse energy normally lost in dynamic braking. The energy storage car is preferably configured to provide functions sufficient to replace one of multiple locomotives used to pull a freight train. Braking methods, and methods to capture and reuse dynamic braking energy on long grades, for such trains are provided.

### CROSS-REFERENCE TO RELATED APPLICATIONS

This application claims priority to U.S. provisional application 60/849,286, filed Oct. 4, 2006.

### FIELD OF THE INVENTION

The present invention relates to regenerative energy storage systems, particularly to those adapted for use with very heavy vehicles, such as hybrid trains or locomotives.

### DESCRIPTION OF THE RELATED ART

Hybrid powertrains have been investigated as a means to reduce fuel consumption and reduce harmful emissions. Hybrid electric powertrains are the most commonly investigated hybrid vehicle powertrain. Hybrid electric powertrains have been found capable of reducing fuel consumption and harmful emissions in some applications, with certain drawbacks.

Two principal drawbacks for hybrid electric powertrains for heavy vehicles are that the storage batteries for such powertrains are expensive, and that current batteries which are not completely cost-prohibitive are severely limited in their ability to quickly capture and store large bursts of energy such as may occur in attempted regenerative braking of a heavy or fast-moving vehicle: As a result, with state of the art hybrid electric technology, a typical hybrid electric passenger car is able to recover and re-use on average only about one-third or less of its kinetic energy lost in braking, a typical prototype heavy-duty hybrid electric truck or bus can recover and re-use only about 15-20% of its kinetic energy lost in braking, and an extremely heavy vehicle such as a hybrid electric locomotive with freight would be expected to recover and re-use only a very small percentage of its kinetic energy in braking. The cost and size of the battery pack needed also greatly increases with the increase in vehicle weight and energy to store.

In addition, the ability to significantly buffer engine operation (i.e., maintain engine operation at good efficiency levels through use of the secondary power system to add or subtract power to the engine output) is also limited for hybrid electric powertrains where the engine is large (again because of the limited efficient charge/discharge rates for batteries which reduce efficiency and durability when charging or discharging at high power levels), such as in heavy vehicles, trains or locomotives.

It is therefore desirable to provide a hybrid powertrain system with the capacity to capture and store energy lost in braking and/or through engine operation buffering in heavy vehicles, particularly freight trains, with good cost, efficiency, and durability.

Freight trains also typically require the use of more than one locomotive in order to meet the temporary high power demands required for accelerating the heavy train from a stop or up a grade. Sometimes the additional locomotive is otherwise unnecessary. As each locomotive is expensive (a new locomotive can cost above $2 million US dollars), it would therefore also be desirable to reduce the number of locomotives needed per freight train by meeting the train's occasional high power demands in a more efficient manner.

### OBJECTS OF THE INVENTION

It is therefore one object of the present invention to provide a commercially viable hybrid powertrain and regenerative braking energy storage system for very heavy vehicles, such as freight trains.

It is also an object of the invention to provide improved methods of operation to improve the cost-effectiveness for the reduction of fuel consumption in such vehicles.

### SUMMARY OF THE INVENTION

In one embodiment of the present invention, a regenerative energy storage system for a train is provided. The energy storage system is preferably placed in a separate car than the locomotive and may be releasably connected with the locomotive. One or more electric motor/generators are provided on the car. These motor/generators receive dynamic braking electrical energy generated from the locomotive's traction motors during braking, and convert the electrical energy to mechanical energy in the form of a rotating shaft. The mechanical energy is then converted by one or more pump/motors to hydraulic pressure, which is then stored by pumping low pressure fluid from a low pressure reservoir to high pressure and storing the pressurized fluid within a high pressure accumulator on the energy storage car. When needed, the stored pressure may be re-used by using the high pressure fluid to run the pump/motors in reverse to drive the electric motor/generators on the energy storage car to produce electrical energy which may then be sent to the traction motors to propel the train.

In another embodiment of the present invention, an electric storage battery is also provided, for storage of a portion of electricity from either the main generator (e.g., when driven by the engine) or the drive motor/generators (e.g., when driven by the wheels in regenerative dynamic braking) within the battery's efficient charging rate. One or more hydraulic pump/motors and high pressure accumulators are still provided for additional conversion and storage of regenerative braking energy and/or excess engine output, thereby creating a hydraulic-electric hybrid train.

An improved method of braking a heavy hydraulic-electric hybrid vehicle or train, such as a hydraulic-electric locomotive, also comprises performing braking events in stages, to allow capture of energy in the hydraulic system in a first braking stage, transfer of that energy from the hydraulic system to an electrical storage battery during a rest in the braking event, then continuing with capture of additional energy in the hydraulic system during a second braking stage. Additional stages may be used as desired.

In a third embodiment of the present invention, a diesel-hydraulic locomotive for use with hydraulic energy storage is provided. A diesel-hydraulic locomotive is used instead of a diesel-electric locomotive to avoid conversion losses involved in converting between electrical and hydraulic energy in the above embodiments. Thus, in this embodiment, a main internal combustion engine of the locomotive drives a first hydraulic pump/motor as a pump to provide pressurized fluid to drive one or more hydraulic pump/motors as motors for propulsion. The first pump/motor and drive pump/motors may operate together much as a hydrostatic transmission, as is known in the art. One or more high pressure accumulators are provided for storage of pressurized fluid from either the first hydraulic pump/motor (driven by the engine) or the drive hydraulic pump/motors (e.g., when used for regenerative “braking” or slowing).

The accumulators may be stored on a separate energy storage car for easier packaging and allowance of greater accumulator volume. An APU (e.g., a separate small diesel engine running an electric generator) is optionally further provided to enable efficient generation of auxiliary power for accessories or other needs at idle or low power conditions, where operation of the main engine is then made unnecessary.

Great cost savings may be achieved with the present invention by enabling substitution of the energy storage cars or locomotives of the present invention for one or more of multiple locomotives used for freight train routes. This could be done on a route-by-route basis. The energy storage car could be sized to be of comparable size to a locomotive and to deliver comparable horsepower when needed. The savings in not needing one locomotive, and to redeploy the locomotive for other use, is significant.

Methods for energy recovery at long grades are also provided. In a first method, energy recovery stations are placed at hills to collect energy from, and supplement energy to, the locomotives. Existence of such stations at long grades would allow for more efficient design of on-board energy storage systems, which would thus need sufficient energy storage capacity for recovery and supplementation for regular braking and coasting, and not the higher requirements for handling long grades. In a second method, ascension of grades with a reduced number of diesel locomotives may be facilitated by phased ascension, comprising a period of ascension supplemented by energy storage, applying brakes and stopped ascension while the energy storage is system is recharged by operation of the combustion engine, and then continued ascension supplemented by energy storage, until ascension of the grade is completed.

### BRIEF DESCRIPTION OF THE DRAWINGS

FIG. 1 is a schematic diagram of a powertrain of the present invention.

FIG. 2 is a schematic diagram of an energy storage car of the present invention.

FIG. 3A presents power flow leading up to and during a sample braking event in a prior art vehicle such as a locomotive.

FIGS. 3B and 3C present power flows and distribution of braking power in a braking event performed in accordance with principles of one aspect of the invention.

FIG. 3D presents power flow in a braking event performed in accordance with an alternative method of the present invention.

FIG. 4 is a schematic diagram of a hydraulic hybrid powertrain for a locomotive of the present invention.

FIG. 5A portrays an energy recovery system for use with trains ascending and descending significant grades.

FIG. 5B is a schematic diagram of an energy storage car for use with FIG. 5A.

FIG. 6A portrays a train ascending a grade with mile markers, for explanation of the method of ascension described in conjunction with FIG. 6B.

FIG. 6B presents power flows over time under a method of the present invention for ascending significant grades.

### DETAILED DESCRIPTION OF THE INVENTION

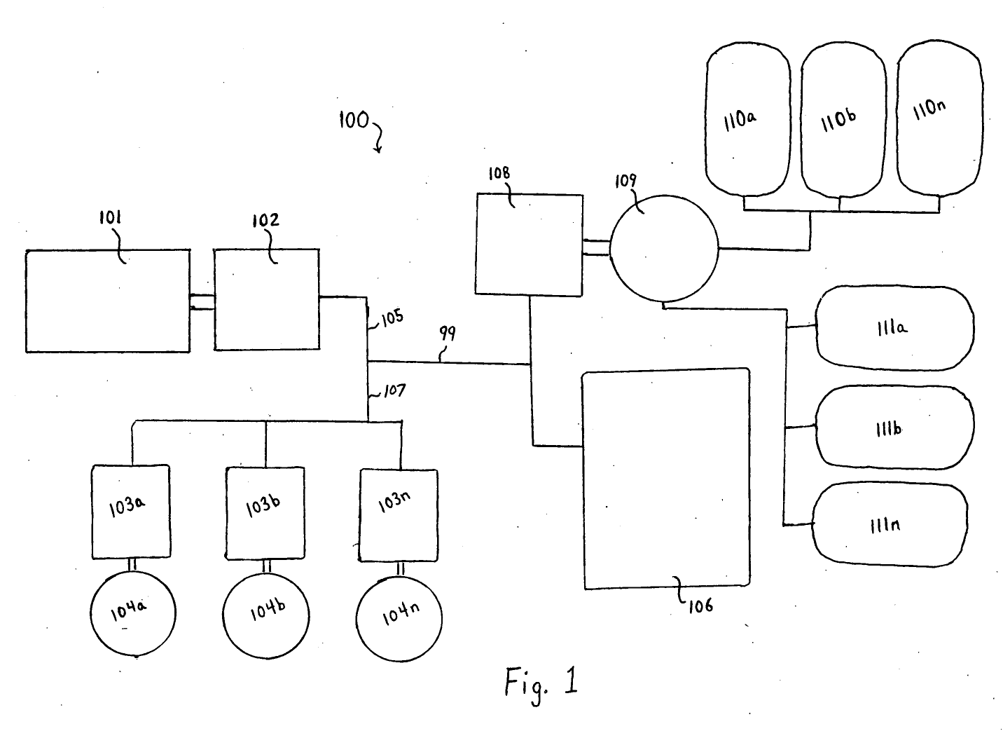

FIG. 1 is a schematic diagram of a powertrain of the present invention for use in conjunction with a diesel-electric locomotive.

Referring to FIG. 1, in diesel-electric locomotive 100, an internal combustion engine 101 drives a first main electric/motor generator 102 to provide electric current through lines 105 and 107 to drive multiple electric motor/generators 103a, 103b . . . to 103n, as motors to drive wheels 104a, 104b . . . to 104n of the locomotive. Any actual number of motors and/or wheels may be used. Propulsion of the locomotive is performed as a known diesel-electric locomotive.

In dynamic braking, electrical power generated by the traction motors 103a-n is routed to motor/generator 108, which then operates as a motor to mechanically drive hydraulic pump/motor 109 as a pump. When driven by motor 108, pump/motor 109 pumps fluid from low pressure accumulators 110a-n to a bank of high pressure accumulators 111a-n, for additional storage of energy. Any number of accumulators may be used. Multiple fluid ports and hose lines may be used per accumulator for increased flow capability (and thus power transfer capability) per accumulator, to reduce the number of accumulators if desired.

By way of example in discussing energy storage, a high pressure accumulator with fluid pressure of 5000 psi can accept or discharge power up to about 250 kW per hose line, assuming a hose line that allows flow of 120 gallons per minute. The number and size (volume) of accumulators used will of course be a matter of design choice depending on, for example, the train's weight and duty cycle, including anticipated peak braking power levels and total braking energy for a braking event. For a large freight train, a desirable total high pressure accumulator volume could easily exceed 10,000 gallons. Stored energy in accumulators 111a-n may later be used for supplemental power in propelling the locomotive (e.g., running pump/motor 109 as a motor to drive generator 108 to send electricity to motor/generators 103a-n to drive wheels 104a-n).

In the embodiment of FIG. 1, an electric storage battery 106 is also provided for storage of a portion of electricity generated from either generator 102 (e.g., excess energy when buffering the engine 101, via line 99) or from motor/generators 103a-n (e.g. for regenerative dynamic braking, via lines 107 and 99). In the event of dynamic braking, electricity generated by motor/generators 103a-n is conveyed by lines 107 and 99 for storage in battery 106 to the extent battery 106 can efficiently accept the additional charge. Likewise, in the event of engine buffering, electricity generated by generator 102 is conveyed by lines 105 and 99 for storage in battery 106 to the extent battery 106 can efficiently accept the additional charge. In either case, electrical power beyond the efficient charging rate of battery 106 is routed to motor/generator 108, which then operates as a motor to drive hydraulic pump/motor 109 as a pump in order to store the energy as fluid pressure within the accumulators 111a-n.

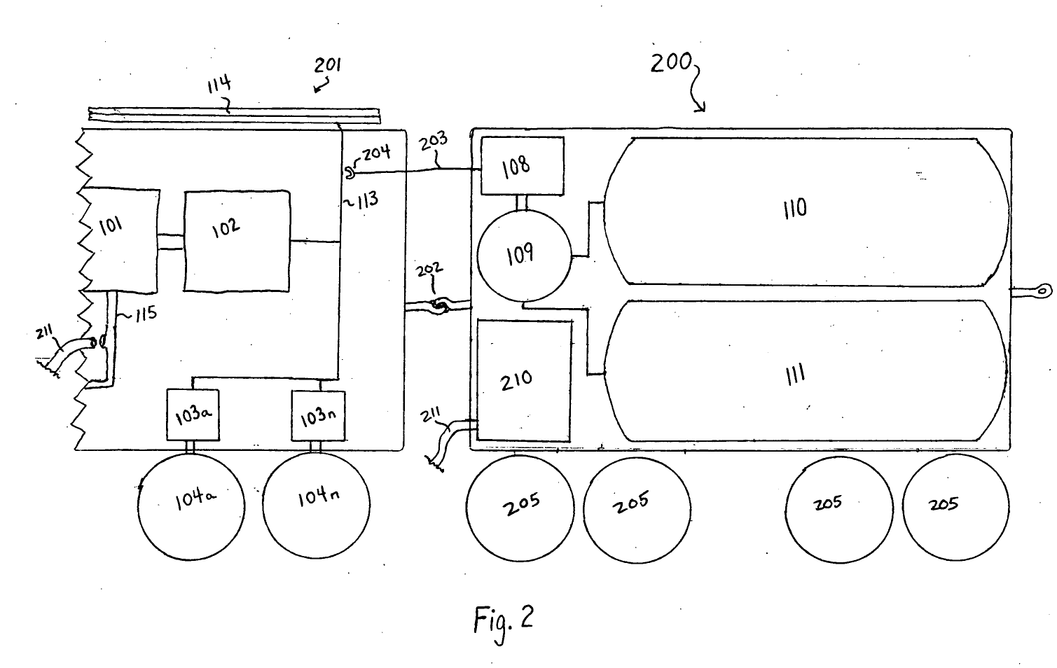

As most locomotives stay in service for many years, the environmental and energy-saving benefits of this technology may be maximized by retrofitting existing diesel-electric locomotives as well. For ease of packaging, each of the additional components could be placed into a freight car that attaches behind the conventional locomotive as illustrated in FIG. 2. To facilitate the retrofitting process by reducing the initial cost of the retrofit to the user, the costs of the retrofit and energy storage train car could be paid teethe retrofitter as a percentage of fuel savings, if desired.

Referring to FIG. 2, an energy storage train car 200 that could be used in conjunction with a slightly-modified conventional diesel-electric locomotive 201 is presented. Items numbered identically to items in FIG. 1 perform equivalent functions and therefore will not again be discussed with regard to FIG. 2. Further, FIG. 2 illustrates that accumulators 110a-n and 111a-n may be replaced with single large volume accumulators 110 and 111 in any of the embodiments if desired. The conventional diesel-electric locomotive 201 is portrayed here to include an electrical line 113 that connects motor/generators 103a-n to resistance grid 114 for conversion of electrical energy to dissipating heat energy during dynamic braking, as is common in the art.

In the embodiment of FIG. 2, the energy storage train car 200 is detachably mechanically connected to locomotive 201 by mechanical connection 202, which could comprise any known means in the art for detachable coupling of train cars. Electrical line 203 extends from the energy storage car 200 and is adapted with a connector 204 to connect into and intercept electrical current passing through line 113 during regenerative braking, and to instead transmit that electrical energy through line 203 to motor/generator 108 (and/or alternatively a storage battery 106) for energy storage. As car 200 is preferably substituted into the freight train pulled by locomotive 201 in place of an additional locomotive that would also normally carry additional fuel that could be used for the train, car 200 also optionally includes an auxiliary fuel tank 210 and an external fuel line 211, which may be connected into fuel line 115 for the internal combustion engine 101 of locomotive 201, in order to provide additional fuel needed for the route.

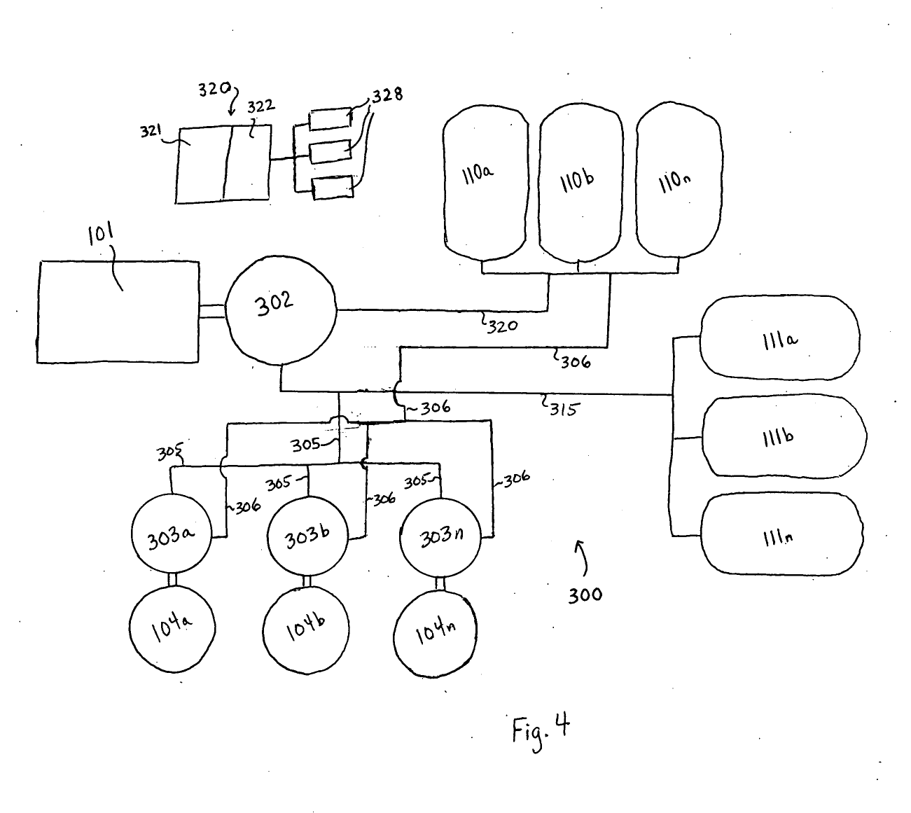

In an alternative embodiment for FIG. 2, pump/motors could be mechanically connected directly to the wheels 205 of car 200 (as shown with pump/motors 303a-n of FIG. 4), for assistance in braking and more direct conversion of the train's kinetic energy to fluid pressure for storage in accumulator 111 without the need for conversion of such energy to electrical energy and back.

Benefits of the locomotive embodiments herein will now be discussed. As stated above, in an extremely heavy vehicle such as a locomotive or other vessel (especially if carrying freight), even the most cost effective energy storage system of batteries would likely recover and re-use much less than 10% of the kinetic energy in braking. The cost and size of the battery pack needed also greatly increases with the increase in vehicle weight and increased energy storage needs. For example, using sample figures, assume a locomotive itself weighs 700,000 kilograms, and the freight train in total weighs eight million kilograms. In braking such a freight train through dynamic braking in the locomotive, the bursts of energy produced may reach three or four thousand kilowatts. Batteries currently cannot capture such large amounts of power in a manner that would be cost-effective (justified by fuel savings) for a line-haul locomotive application.

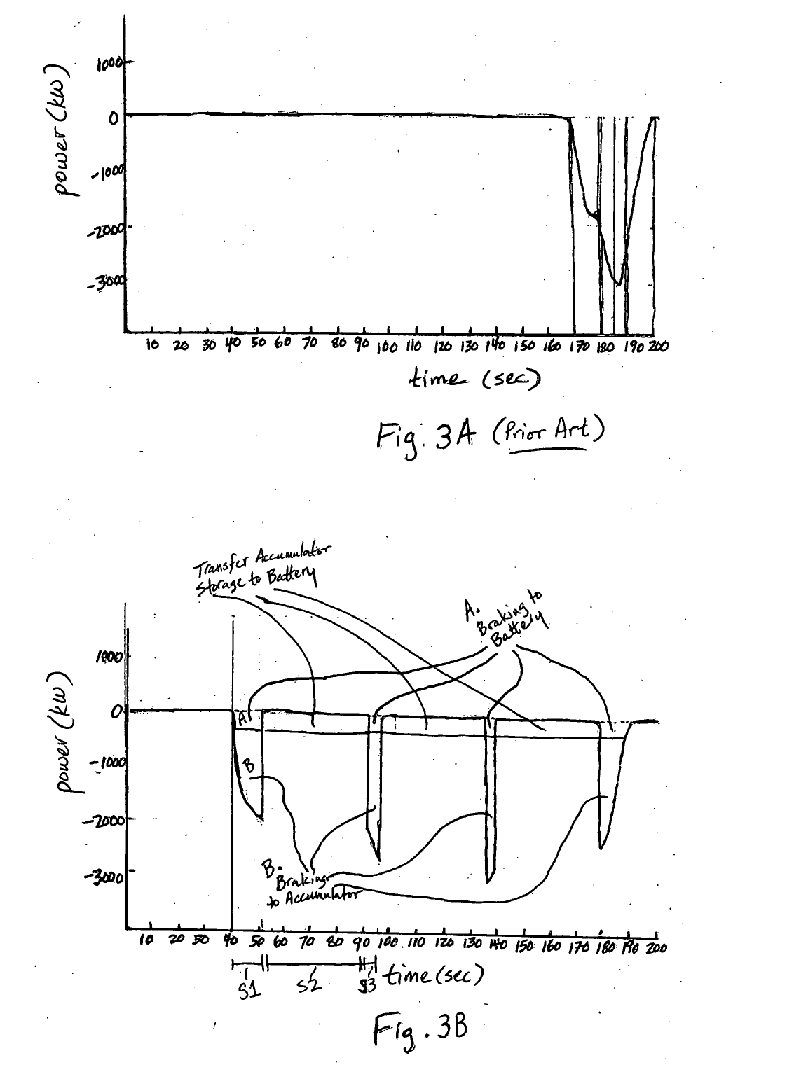

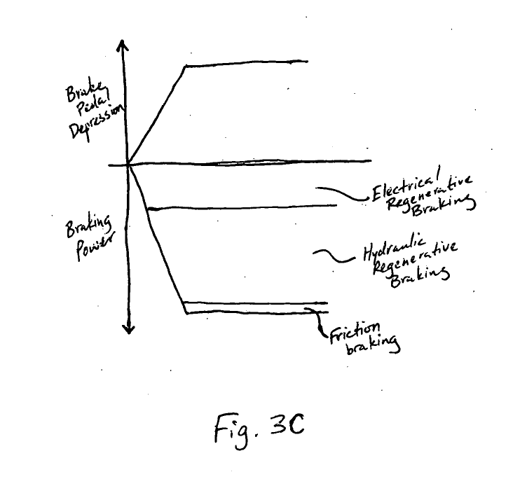

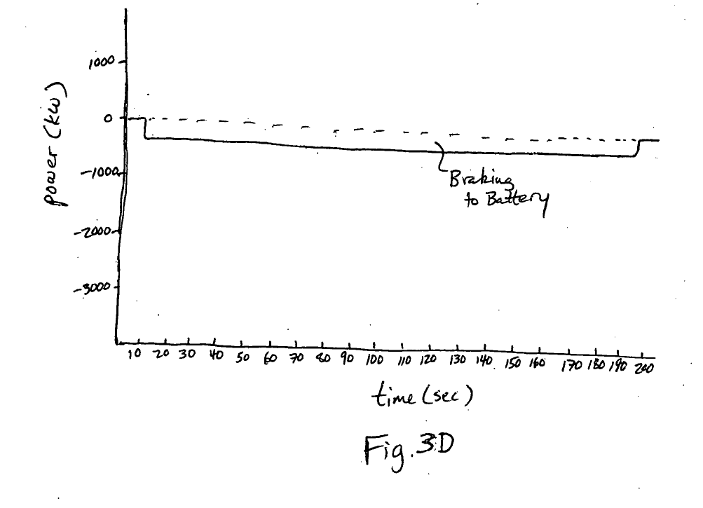

With the hybrid trains described herein, significant cost savings and fuel reduction savings could also be made if used in conjunction with a more cost-effective method of braking. FIG. 3A presents dynamic braking power flow leading up to and during a sample braking event of a locomotive according to the prior art. FIGS. 3B and 3C present power flows in a braking event involving the same amounts of braking energy, but performed in accordance with additional principles of the present invention. Referring to FIG. 3B, the braking event is broken up into multiple stages over time to allow cost-effective capture and storing of the braking energy. In the first step, S1, dynamic braking is performed, with a first portion A of the braking energy stored from the traction motor/generators to a battery 106 at an efficient charging rate for the battery. Simultaneously, excess braking energy B is stored through the hydraulic system in the accumulators 111a-n, as also indicated in FIG. 3C. As the energy storage in the accumulators 111a-n approaches capacity, braking is stopped in step S2, as energy storage is then transferred from accumulators 111a-n through pump/motor(s) 109 and motor/generator 108 to the storage battery 106. As the accumulators now reach again a low threshold value of energy storage, braking is commenced again in step S3 in the same manner as for step S1. Further stages may be used as needed until the braking event is complete. Friction brakes may additionally be used in addition to regenerative braking, as indicated in FIG. 3C. At the end of the braking event, the accumulators preferably retain some energy storage for use in subsequent relaunching after the stop.

Although the preferred method of braking for greater recovery of energy set forth above takes longer and would require more braking distance than the prior art, it may be acceptable in situations where braking may be planned in advance (e.g. on train routes with preset stopping points). For best efficiency, the braking event would be controlled by a microprocessor which receives accumulator energy storage level inputs. Activation of the braking method could occur through a driver-operated button or switch when a faster braking event is not needed. Through use of this braking method in conjunction with the apparatus herein, a smaller, lighter and less expensive energy storage system may be used, and a more attractive cost payback obtained.

Where practical, an alternative efficient braking method is also presented in FIG. 3D, in which the braking energy is at times recovered solely in an electrical battery at an acceptable charge rate, and the braking event is managed such as to generate electricity only at a rate that can be efficiently stored in the storage battery. This method may also be used on any hybrid electric locomotive, and does not require use of a hydraulic energy storage system as in the other apparatuses of the present invention.

As a most preferred embodiment, a hydraulic hybrid locomotive 300 is presented in FIG. 4 which reduces the number of components and avoids the need for conversion (with related losses) of electrical energy to hydraulic energy and vice versa as in the previous embodiments. Items numbered identically to items in FIG. 1 perform equivalent functions and therefore will not again be discussed with regard to FIG. 4.

Referring to FIG. 4, internal combustion engine 101 drives a first main pump/motor 302 to pump fluid from one or more of low pressure accumulators 110a-n (via line 320) to high pressure. The pressurized fluid is sent through hydraulic line 305 to drive multiple hydraulic pump/motors 303a, 303b . . . 303n, as motors to drive wheels 104a-n of the locomotive, with low pressure fluid returning to one or more low pressure accumulators 110a-n through fluid line 306. High pressure accumulators 111a-n are provided for storage of a portion of pressurized fluid from pump/motor 302 (e.g., through line 315, due to excess energy when buffering the engine 101) or from motors 303a-n (e.g. via lines 305 and 315 due to regenerative braking). In the event of regenerative braking, low pressure fluid from low pressure accumulators 110a-n via line 306 is pressurized by pump/motors 303a-303n and conveyed by lines 305 and 315 for storage in high pressure accumulators 111a-n. The number and volume of accumulators used is a matter of design choice depending on, for example, the train's weight and duty cycle. Stored energy in accumulators 111a-n may later be used to supplement power in moving the locomotive (e.g., sending pressurized fluid through lines 315 and 305 to run pump/motors 303a-n as motors to drive wheels 104a-n).

The hydraulic hybrid locomotive of FIG. 4 is preferably also provided with a small auxiliary power unit (APU) 320. APU 320 comprises small internal combustion engine 321 and electric generator 322, to provide energy for air conditioning and other equipment and accessories (together represented collectively as 328), allowing extended engine-off periods (and reduced idling) of main engine 101. In some duty cycles, idling of the main engine 101 with a conventional drivetrain would otherwise be needed as much as 60% of the time. One commercially available APU goes by the name “K9.”

One preferable use for the configuration of FIG. 4 is as a locomotive switcher in a switching yard because of the frequent stop-go cycling and long idling times, with high power bursts of short duration typical of such duties, which are especially suitable for the use of hydraulics in energy capture and reuse.

It should be noted in conjunction with locomotive embodiments of the inventions herein, that because of the extremely low rolling resistance of the trains, and because of the regenerative braking system's high capacity for capturing and re-using braking energy efficiently herein, any weight gain from the additional components required for the system will not significantly undermine the fuel efficiency gains for the trains.

The benefits obtained by the inventions herein for any particular vehicle or vessel will, of course, be significantly affected by the duty cycle. For example, the fuel efficiency benefits of the energy storage configurations herein will be much higher for duty cycles involving frequent stop-and-go operation, such as for a switcher locomotive, or some vehicle duty cycles, as will be understood in the art.

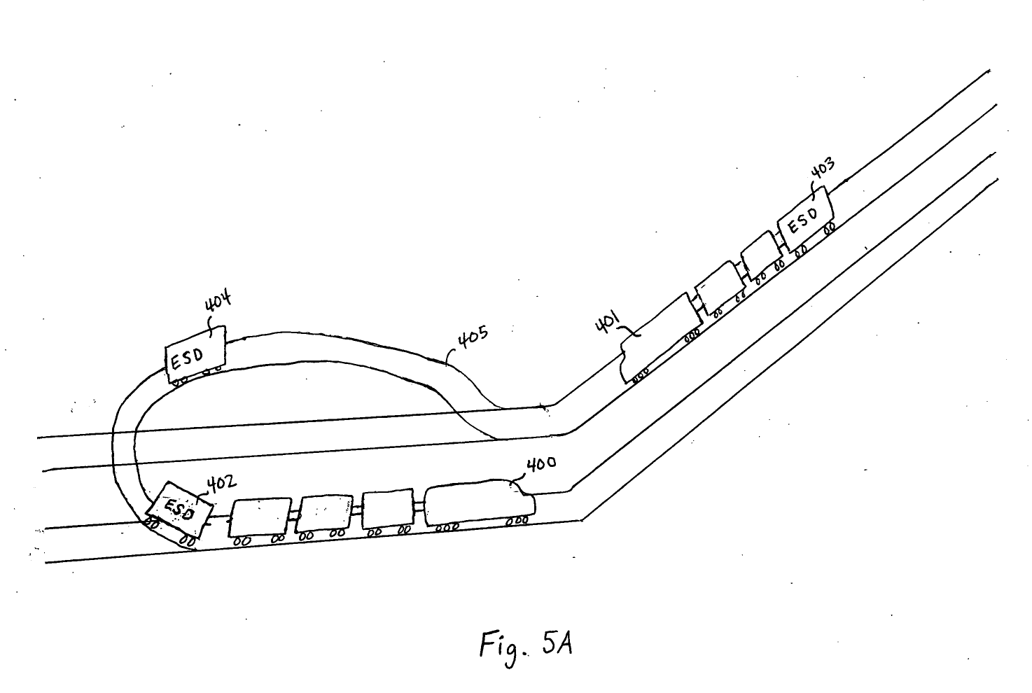

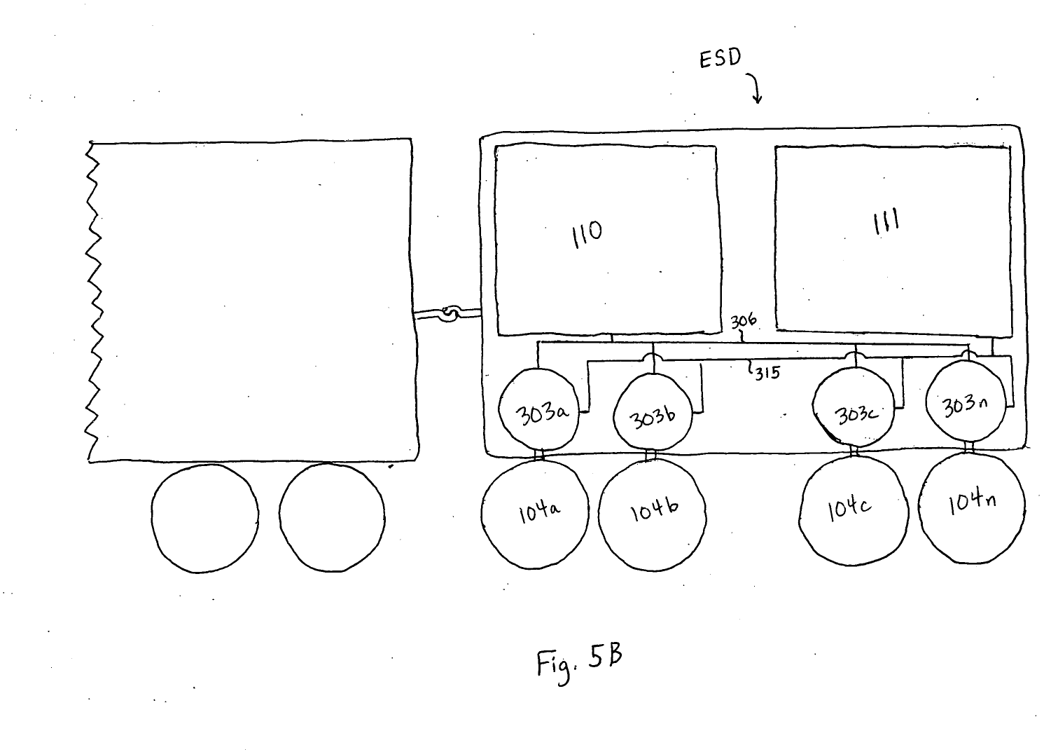

For train routes with long grades (e.g., mountain passes), it could also be beneficial to provide energy storage mechanisms that stay local to that portion of the route. One such system is portrayed in FIG. 5A. In this embodiment, energy storage cars (labeled ESDs in FIG. 5A) are provided which may be connected onto the train and let go as desired. The ESD can be similar to car 200 in FIG. 2, but preferably omits fuel tank 210 and fuel line 211. The ESD could also be configured to use pump/motors for the regenerative braking (similar to pump/motors 303a-n of FIG. 4), for greater energy recovery efficiency and possibly eliminating the need for electrically connecting the energy storage car to the train's locomotive (i.e., the ESD could potentially be connected anywhere to the train). A sample ESD is illustrated in FIG. 5B. The components in the ESD of FIG. 5B have already been discussed above for their purposes of regenerative braking and/or power supplementation for the train, and therefore need not be explained again for one in the art to understand their operation in this embodiment.

Returning to FIG. 5A, prior to ascent up a long grade, a train 400 picks up one or more energy storage cars (e.g., ESD 402) with stored energy and uses the stored energy for supplemental propulsive energy to help climb the grade. The train may then release the ESD car(s) on the way, in one or more stages, if desired. The train then either retains the energy storage cars or picks up “emptied” energy storage cars and brings them down the following downslope, with the energy storage cars storing energy from dynamic braking of the train as it descends the hill, as is shown for a second train 401 and ESD 403 in FIG. 5A. The “full” storage cars (e.g. ESD 404) are then separated from the train 401 (e.g., via a re-routing track 405) and moved to be picked up again by the next available train preparing to head up the slope in the opposite direction. The energy storage cars are therefore cost-effectively locally cycled and recycled going up and down the hill in this embodiment.

Alternatively, dynamic braking energy may be electrically collected from trains descending a slope and reused by other trains ascending a slope by use of overhead (catenary) wires along the grades to electrically collect and transmit the dynamic braking energy to an energy storage device nearby (e.g. a flywheel), or to an electrical power grid, and then to another train to use in ascending the slope.

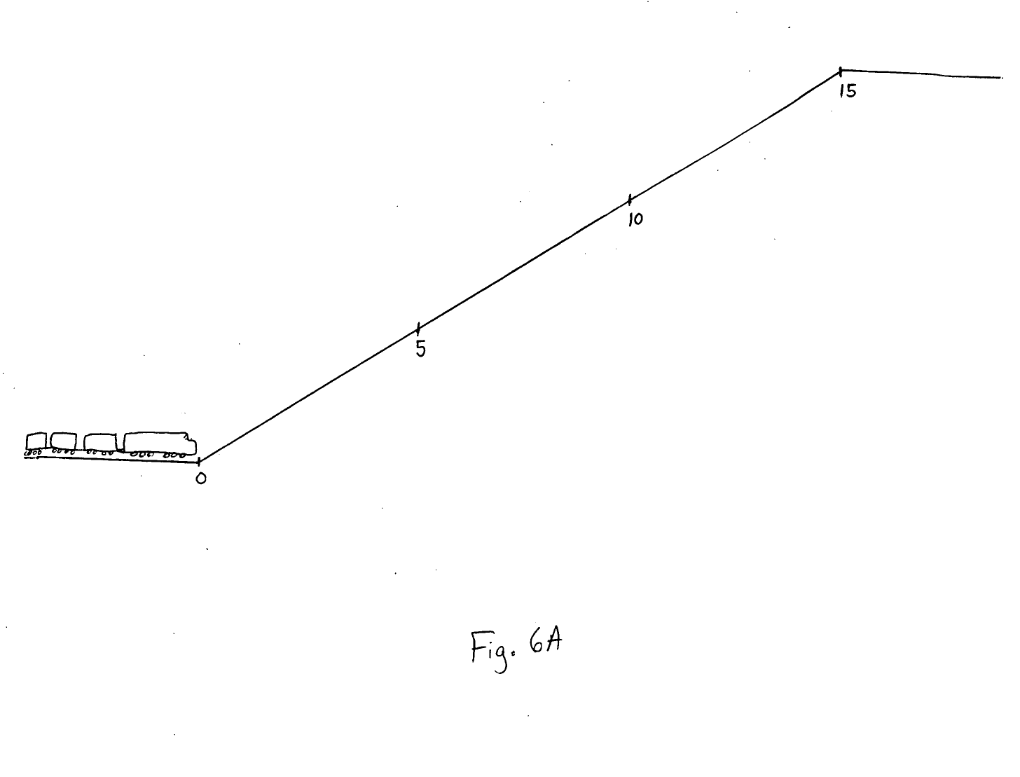

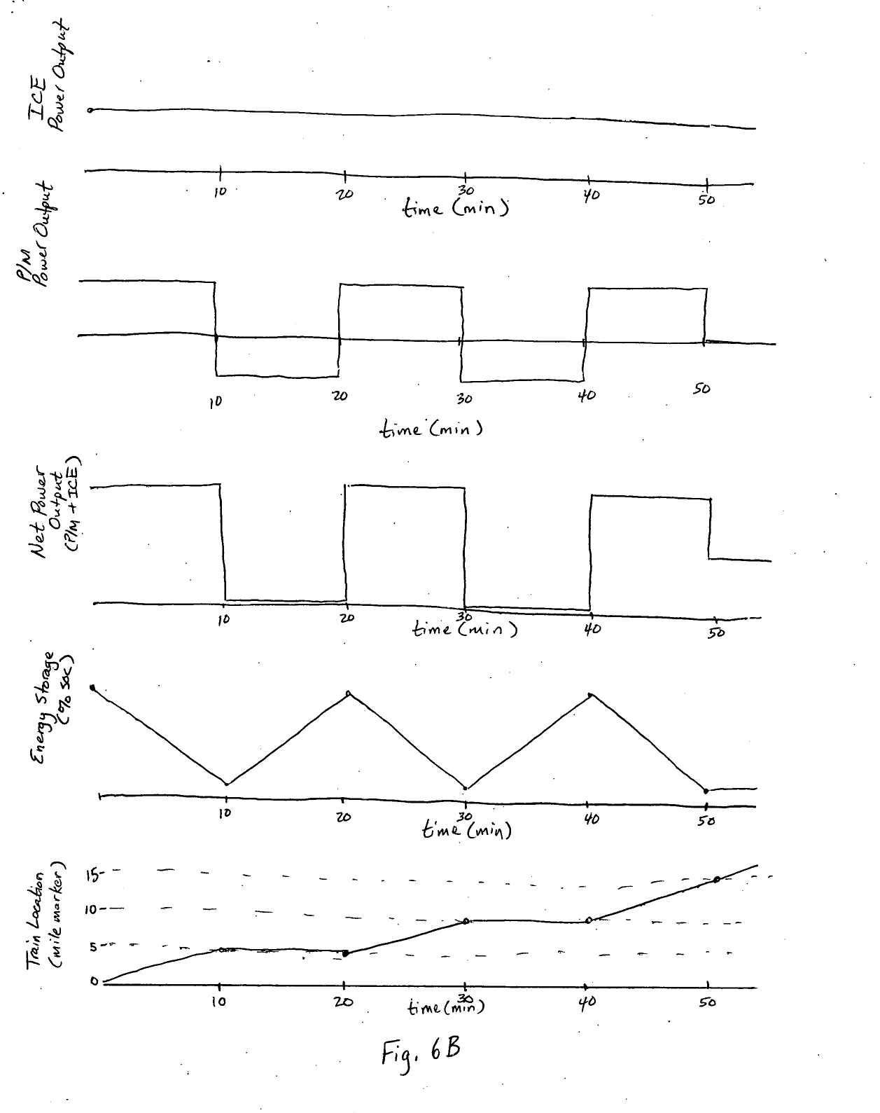

Ascension up a long grade (as illustrated in FIGS. 6A and 6B) by a freight train consist wherein one or more energy storage cars 200 of FIG. 2 is substituted in place of one of the consist's multiple locomotives may also be facilitated in part by another method of the present invention. In this method, stored energy from the energy storage device is used to supplement the locomotive's internal combustion engine's output. In the event that the energy storage device reaches a preset minimum energy storage level while the train is still attempting to ascend the grade, the train is temporarily stopped while the internal combustion engine is used to recharge the energy storage device to a desired level. Once recharged, the train again may proceed up the grade with the newly stored energy in the energy storage device again used to supplement the locomotive's internal combustion engine's output. This process may be repeated as necessary.

Sample power flows which show a sample operation under such a method are presented in FIG. 6B, the graphs of which further explain how the ascension up a long grade may be made in ascending and recharging stages for the sample grade of FIG. 6A by coordinating the operation and power output from the combustion engine, pump/motor and energy storage device(s). This method could also be used with batteries or other energy storage devices in place of accumulators if desired, and is thus not limited to the apparatus of car 200 herein.

For starting the train from a stop, the internal combustion engine(s) may likewise be used to build fluid pressure in the accumulator(s) 111, which can then be used to help with initial launch of the train if desired. Alternatively in such a scenario, to avoid the losses of having the energy go to the accumulators, the accumulators may be temporarily valved out for hydrostatic operation (with a pressure relief valve to avoid overpressure) to quickly build the fluid pressure for a burst of higher power output to launch the train.

From the foregoing it will be appreciated that, although various specific embodiments of the invention have been set forth herein, further modifications could also be made without deviating from the spirit and scope of the invention. For example, it will be well-understood that either more or fewer hydraulic lines may be utilized to perform the same functions as the hydraulic lines mentioned herein. Higher (or lower) hydraulic pressure may also be used in energy storage. Likewise, it will be recognized that operatively connected devices may be integrated, rearranged, or separated with mechanical or other intervening links, as may be desired. It will also be understood that various aspects of the different embodiments could be combined or switched without affecting the basic invention. Therefore, the scope of the present invention is intended to be limited solely by the claims presented herein.

For purposes of this application, the phrase “a pump/motor mounted on the train car and configured to be driven as a pump by mechanical rotational energy generated as a result of braking of the train” encompasses a pump/motor (e.g., 303a-n) driven directly by the train's kinetic energy in braking or a pump/motor (e.g. 109) driven by an electric motor/generator indirectly powered through the train's dynamic braking energy.

Finally, for purposes of the methods of this application related to handling long grades, unless otherwise indicated, the generic term “energy storage device” may include off-board sources/supplies of energy that the train may be connected to (e.g. through overhead lines), including energy generating stations or electrical power grids, even if such stations do not technically “store” energy in a particular given case.

I claim:

1. A train, comprising:
a train car;
a pump/motor mounted on the train car and configured to be driven as a pump by mechanical rotational energy generated as a result of braking of the train, to pump a working fluid from a low pressure to a high pressure;
a high pressure hydraulic accumulator, mounted on a train car and fluidly connected to the pump/motor, for storage under pressure of the working fluid pressurized by the pump/motor.

2. The train of claim 1, further comprising a locomotive with an internal combustion engine, and wherein the pump/motor is further configured to be driven by the pressurized fluid in the hydraulic accumulator, to provide power output used to help propel the train in supplementation to power output from the internal combustion engine.

3. The train of claim 2, wherein the collective power output from internal combustion engines on the train are insufficient to propel the train up one or more grades in the train's route without the supplemental power provided by the pump/motor driven by the hydraulic accumulator.

4. The train of claim 2, additionally comprising an electric motor/generator configured to receive electrical energy generated in dynamic braking of the train and to convert that electrical energy to mechanical rotational energy to drive the pump/motor as a pump to pressurize fluid for storage in the high pressure accumulator.

5. The train of claim 4, wherein the power output from the pump/motor driven by the pressurized fluid from the hydraulic accumulator helps propel the train by being used to drive the electric motor/generator as a motor to drive wheels of the train.

6. A method of regenerative braking for a moving vehicle, comprising:
using a first portion of kinetic energy of the moving vehicle to drive an electric motor/generator as a generator to produce electrical energy for storage in an electric storage battery, thereby providing a first quantum of braking power for the vehicle, said first quantum of braking power corresponding to an efficient charging rate for the battery;
when sufficient energy storage capacity in a hydraulic accumulator in the moving vehicle is available, using a second portion of kinetic energy of the moving vehicle to drive a hydraulic pump to pressurize fluid for storage in a hydraulic accumulator, thereby providing a second quantum of braking power for the vehicle.

7. The method of claim 6, further comprising, when sufficient energy storage capacity in the hydraulic accumulator is not available:
temporarily discontinuing the application of braking power to the vehicle;
driving the hydraulic pump with pressurized fluid as a hydraulic motor to drive an electric generator to produce electrical energy for additional storage in the electric storage battery; and
when sufficient energy storage capacity in the hydraulic accumulator is again available, using a third portion of kinetic energy of the moving vehicle to drive the hydraulic pump to pressurize fluid for storage in the hydraulic accumulator, thereby providing a new quantum of braking power for the vehicle.

8. The method of claim 7, wherein the vehicle is a train.

9. A locomotive, comprising:
a first internal combustion engine, for production of mechanical power from fuel energy for use in propulsion of the locomotive;
a hydraulic pump/motor, configured to be driven as a pump using braking energy from the locomotive to pressurize fluid for storage in a high pressure hydraulic accumulator.

10. The locomotive of claim 9, further comprising an auxiliary power unit, comprising a second internal combustion engine and an electric generator, for production of electricity for use in the vehicle when the first internal combustion engine is off.

11. The locomotive of claim 9, further comprising:
a first plurality of electric motor/generators, mechanically connected to the drive wheels of the locomotive, configured to be driven by the drive wheels as generators generating electrical energy during a braking event for the locomotive; and
a storage battery, electrically connected to the first plurality of electric motor/generators and configured to store a portion of electrical energy generated by the motor/generators at a power level within an efficient charging rate for the battery; and
wherein the hydraulic pump/motor is mechanically driven as a pump during the braking event, by either the drive wheels or an electric motor, using energy from the braking event for the locomotive, and converts to fluid pressure for storage in a high pressure hydraulic accumulator a portion of energy from the braking event which could not be stored in the battery within the efficient charging rate for the battery.

12. The locomotive of claim 11, wherein the locomotive comprises two units, the first unit containing the internal combustion engine and the first plurality of electric motor/generators, and the second unit comprising a train car operatively connected to the first unit and containing the storage battery, the hydraulic pump/motor, and the high pressure hydraulic accumulator.

13. The locomotive of claim 9, wherein pressurized fluid stored in the high pressure hydraulic accumulator is used to drive the hydraulic pump/motor as a motor to assist in propulsion of the locomotive.

14. The locomotive of claim 9 wherein the locomotive is a switcher locomotive.

15. The locomotive of claim 9 wherein the locomotive is a line-haul locomotive.

16. A method for transporting goods by line-haul freight train, comprising:
hauling freight along a route from a first location to a second location utilizing a line-haul freight train consist wherein the collective peak power output from internal combustion engines of all of the locomotives of the freight train is insufficient by itself to provide the propulsive power necessary for the freight train to complete the route; and
supplementing the power output from the internal combustion engines of the locomotives with power output from an energy storage device to help the freight train complete the route.

17. The method of claim 16, further comprising:
using one or more of the internal combustion engines of the locomotive to charge the energy storage device, and then using the combined power output from the internal combustion engines of all of the locomotives of the freight train plus supplemental power output from the energy storage device to launch the train or ascend a grade on the route.

18. The method of claim 17, further comprising ascending the grade in more than one stage and stopping the train in between stages to recharge the energy storage device before continuing the ascension of the grade.

19. The method of claim 16, wherein the step of supplementing the power output from the internal combustion engines with power output from an energy storage device comprises reusing dynamic braking energy that has been collected from a separate train descending a slope.

20. The method of claim 16, wherein the step of supplementing the power output from the internal combustion engines with power output from an energy storage device comprises using power from an electrical power grid to help the freight train ascend a grade on the route.

21. The method of claim 19, further comprising:
converting dynamic braking energy generated from a first train descending a slope into hydraulic fluid pressure;
storing said fluid pressure as stored energy in a hydraulic accumulator on-board a detachable energy storage train car of the first train;
detaching the energy storage train car from the first train;
attaching the energy storage train car to the line haul freight train prior to ascending a slope;
utilizing the energy stored in the energy storage train car to help propel the freight train up the slope.
